(19) United States
(12) Patent Application Publication
(10) Pub. No.: US 2003/0077361 A1
(43) Pub. Date: Apr. 24, 2003

(54) Glazed baking products

(75) Inventors: Christopher John Cobham Smail, Wiltshire (GB); Laura Nicole Honey, Surrey (GB)

Correspondence Address: SIERRA PATENT GROUP, LTD., P O BOX 6149, STATELINE, NV, 89449, US

(73) Assignee: Bakehouse, Ltd.

(21) Appl. No.: 10/231,961

(22) Filed: Aug. 30, 2002

(30) Foreign Application Priority Data
Aug. 31, 2001 (GB) 0121194.5

(51) Int. Cl. A23G 3/00

(52) U.S. Cl. 426/94

(57) ABSTRACT

The invention comprises an improved dough mixture and processes for the preparation thereof which is improved by possessing a coating of a pre-glaze composition, wherein the composition comprises mainly a complex sugar, such that baking results in a product with a glazed appearance.

### PRIOR APPLICATION

This application claims priority to United Kingdom whose application number is 0121194.5 filed on Aug. 31, 2001.

### BACKGROUND

A problem which has been encountered in the formation of baked goods is that, after baking, many pastry doughs have a dull, flaky or mottled appearance. Traditionally, this problem has been overcome by applying a glaze, such as thinned apricot jam, to the product after said product has been baked. However, if the glaze is not applied equally and consistently to the surface of the baked goods, then this may have a detrimental effect upon their appearance. This problem has become of particular importance with the emergence of bake-off foodstuffs. Bake-off foodstuffs involve the manufacture of an unbaked dough mixture which is generally baked at the point of sale, often by unskilled personnel. In certain situations, it may also be impractical to apply the glaze due to the space needed for this operation. Since the glaze is responsible for the shiny appearance of the baked goods, it is important to ensure that it is correctly applied. Clearly an incorrect application of the glaze will result in a detrimental effect upon the aesthetic properties of the final baked goods.

### SUMMARY

The present invention discloses a dough product that comprises a dough mixture, part of the outer surface of which has been coated with a pre-glaze composition comprising a complex sugar, and wherein said dough mixture is frozen.

The present invention also relates to a process for preparing a dough product which comprises forming a dough mixture, coating part of the outer surface of said dough mixture with a pre-glaze composition comprising a complex sugar and freezing said dough mixture.

### DETAILED DESCRIPTION

The present invention relates to the application of glazes onto foodstuffs to be baked, in particular but not exclusively pastries, breads, cakes and biscuits, as well as savoury products.

The present invention clearly provides an advantage over the prior art since the products and processes described herein provide a means for producing goods which, when baked, have an appearance which could only previously be achieved by applying a glaze to a baked product. This has advantages over methods used previously since the pre-glaze composition may be applied to the dough mixture in a controlled manner which ensures a uniform and shiny appearance of the eventual product, and, furthermore, the present invention also negates the need to apply a glaze to the product after baking. Since the application of a glaze has previously involved the use of brushes and glazing tools which may be dirty, the present invention is more hygienic.

The pre-glaze composition comprises mainly a complex sugar which is preferably polydextrose, and can be in the form of liquids, powders or granules. If the pre-glaze composition is in the form of a liquid it will preferably be applied onto the dough mixture by spraying. Such a liquid may be in the form of a solution, such as a 70% solution or a saturated solution. If the pre-glaze composition is in the form of solids or granules, it will preferably be applied onto the dough mixture by dusting or sprinkling. The pre-glaze composition is preferably applied directly onto the dough mixture. The procedures for spraying, dusting or sprinkling the pre-glaze composition onto the dough mixture may be performed in a mechanized manner.

In one example, the pre-glaze composition typically comprises at least about 60% complex sugars, preferably at least about 70% complex sugars, more preferably at least about 80% and most preferably at least about 90%. When the pre-glaze composition is a sugar, such percentages refer to the dry weight of the composition.

In another example, the pre-glaze composition typically comprises at least about 60% of a multi dextrose or polydextrose, preferably at least about 70% and more preferably at least about 80%. Alternatively, the pre-glaze composition may comprise a combination of sugar, glucose syrup and modified starch. The combination of sugar, glucose syrup and modified starch typically comprises at least about 60% of the pre-glaze composition, preferably at least about 70% and more preferably at least about 80%.

The pre-glaze composition comprising a multi dextrose or polydextrose or a combination of sugar, glucose syrup and modified starch may further comprise monosaccharides, disaccharides or polysaccharides.

The pre-glaze composition may comprise any sugars, which may include monosaccharides, such as fructose, dextrose, glucose and galactose, disaccharides, such as sucrose, lactose and maltose, sugar alcohols, such as sorbitol, mannitol, xylitol, maltitol and lactitol, cyclic oligosaccharides, such as cyclodextrin and cyclofructin and polysaccharides, such as polydextrose.

Typically the composition will comprise a mixture comprising polydextrose and lactose or alternatively a mixture comprising polydextrose and sorbitol. If a mixture of polydextrose and sorbitol is employed then the mixture typically comprises from about 70% to about 95% polydextrose, preferably at least about 80% and more preferably at least about 90%, the mixture typically comprises from about 0.5% to about 3% sorbitol, preferably not more than about 2.5% and more preferably not more than about 2%, this mixture may also comprise up to about 4% glucose.

The pre-glaze composition may also comprise a variety of other ingredients which may be added to enhance the appearance or taste of the final baked product. These ingredients may include dried fruit, such as raisins, sultanas and apple, fresh fruits, such as orange, pear and apple, freeze-dried fruit, such as raspberries, nuts, such as hazelnuts, pecan nuts and almonds, chopped nuts, sliced nuts, herbs, such as basil or rosemary, spices, such as cinnamon or nutmeg, flavouring ingredients, such as chocolate or toffee, coloring ingredients, additives, or preservatives. These ingredients may be applied to the surface of the unbaked dough mixture either before, or after, the application of the pre-glaze composition, or may be mixed with the pre-glaze composition such that the different components are applied simultaneously.

A further advantageous aspect of the present invention is that the application of the pre-glaze composition to part of the surface of the dough mixture may provide an adhesive effect with regard to the addition of other ingredients. This clearly provides an advantage from a production point of view and provides a further advantage in that the product will be more likely to retain its manufactured appearance during transportation.

Another advantageous aspect of this invention is that, after baking, the pre-glaze composition forms a shiny shell which provides a light crunchy texture to the pastry. This shell may impart some non-stick properties to the exterior of the baked goods. Further, especially if toppings have been applied to the product, the shell can assist in holding the product together. Accordingly, the shell may reduce the risk of damage to the product, in particular during transportation. The shell can also act to protect the product from the environment and to reduce staling. The dough product is generally baked in an oven.

The pre-glaze composition may be applied to the dough mixture prior to the freezing process or, alternatively, the pre-glaze composition may be applied to a previously frozen product. The frozen dough product may be baked directly from frozen or may be defrosted prior to baking.

The present invention also relates to a baked product which is produced by baking a dough product, the surface of which has been coated with a composition comprising polydextrose. The term “baked product” can mean any product formed by baking a dough, typically pastries, breads, cakes and biscuits, however, it also applies to savoury products such as savoury croissants or savoury puff pastry products. In particular the present invention relates to pastries. The term “dough mixture” can mean raw croissant, Danish or puff pastry dough or raw bread dough or the like. The present invention relates to unbaked doughs which are frozen at the point of manufacture and are baked at the point of sale. In this situation, the point of manufacture and the point of sale may be same or may be different.

### EXAMPLE

An apricot filled unbaked Danish pastry was dusted with a pre-glaze composition prior to freezing. The pre-glaze composition comprised a mixture of a polydextrose, sorbitol and glucose. The relative amounts of each component in the pre-glaze composition were at least 90% polydextrose, less than 2% sorbitol and less than 4% glucose. The frozen pastry was then baked in an oven at around 190° C. for around 18 to 20 minutes. After baking the appearance of the Danish pastries were compared to Danish pastries prepared in an identical manner but which were, however, not pre-glazed.

The pre-glazed pastries had a shiny appearance whilst the non pre-glazed pastries appeared dull.

A similar test was performed by comparing the appearance of cherry and almond pastries, however, in this case the pre-glaze comprised a mixture of polydextrose and lactose. The pre-glazed pastries were more shiny and had a more caramelised appearance when compared to the non pre-glazed pastries.

What is claimed is:

1. A dough product comprising:
a dough mixture having part of the outer surface of said dough mixture coated with a pre-glaze composition, wherein said dough mixture is frozen.

2. The product according to claim 1 wherein the pre-glaze composition comprises a complex sugar.

3. The product according to claim 2 wherein the complex sugar is one of a multi-dextrose and a polydextrose.

4. The product according to claim 2 wherein the complex sugar comprises a mixture of sugar, glucose syrup and modified starch.

5. The product according to claim 3 wherein the pre-glaze composition further comprises at least one of a monosaccharide, disaccharide and polysaccharide.

6. The product according to claim 4 wherein the pre-glaze composition further comprises at least one of a monosaccharide, disaccharide and polysaccharide.

7. The product according to claim 3 wherein the pre-glaze composition further comprises at least one of a glucose and sorbitol.

8. The product according to claim 1 wherein the dough product is a bake-off foodstuff.

9. A process of preparing a dough product comprising:
forming a dough mixture;
coating part of an outer surface of said dough mixture with a pre-glaze composition; and
freezing said dough mixture.

10. The process according to claim 9 wherein said pre-glaze composition comprises a complex sugar.

11. The process according to claim 10 wherein said complex sugar is one of a multi-dextrose and a polydextrose.

12. The process according to claim 10 wherein said complex sugar comprises a mixture of sugar, glucose syrup and modified starch.

13. The process according to claim 11 wherein said pre-glaze composition further comprises at least one of a monosaccharide, a disaccharide and a polysaccharide.

14. The process according to claim 12 wherein said pre-glaze composition further comprises at least one of a monosaccharide, a disaccharide and a polysaccharide.

15. The process according to claim 11 wherein said pre-glaze composition further comprises at least one of glucose and sorbitol.

16. The process according to claim 9 wherein said pre-glaze composition is in the form of a liquid and the coating step comprises spraying the liquid.

17. The process according to claim 9 wherein said pre-glaze composition is in one of a granulated form and in the form of a powder and the coating step comprises one of sprinkling the granules and dusting the powder.

18. The process according to claim 9 wherein said pre-glaze composition is applied prior to freezing the dough mixture.

19. The process according to claim 9 wherein said pre-glaze composition is applied after freezing the dough mixture.

20. The process according to claim 9 wherein the dough mixture is part-baked prior to freezing.

21. The process according to claim 9 further comprising:
baking the dough product in an oven.
